(19) United States
(12) Patent Application Publication
(10) Pub. No.: US 2026/0264174 A1
(43) Pub. Date: Sep. 10, 2026

(54) CUTTING MACHINE

(71) Applicant: NISSAN TANAKA CORPORATION, Iruma-gun, Saitama (JP)

(72) Inventors: Kyouji HANAKI, Iruma-gun (JP); Michiharu ANZO, Iruma-gun (JP)

(21) Appl. No.: 18/875,550

(22) PCT Filed: Jul. 4, 2023
(86) PCT No.: PCT/JP2023/024788

§ 371 Date: Dec. 16, 2024

(30) Foreign Application Priority Data
Jul. 8, 2022 (JP) 2022-110571

(51) Int. Cl. B23K 26/38; B23K 26/03; B23K 26/08

(52) U.S. Cl. CPC B23K 26/38; B23K 26/03; B23K 26/0884

(57) ABSTRACT

A cutting machine includes a cutting table on which a material to be processed is placed; a cutting machine body including a running carriage configured to be movable in a running direction, a movement mechanism configured to move in the running direction together with the running carriage and to be movable in a vertical direction and in a lateral direction in a cutting space on the upper side of the cutting table, a body cover portion configured to cover the cutting space, and a cutting head positioned in the cutting space and supported by the movement mechanism to cut the material to be processed; an operating deck unit provided on one side in the lateral direction with respect to the cutting machine body; and an operating unit provided in an external space on the upper side of the operating deck unit and configured to operate the cutting machine body, wherein the operating deck unit includes an opening and closing door on the other side in the lateral direction to separate the cutting space from the external space.

### TECHNICAL FIELD

The present invention relates to a cutting machine. Priority is claimed on Japanese Patent Application No. 2022-110571, filed Jul. 8, 2022, the content of which is incorporated herein by reference.

### BACKGROUND ART

Conventionally, cutting devices equipped with cutting torches such as laser torches have been widely used as cutting devices (cutting machines) for cutting materials to be processed. The cutting device cuts a material to be processed with a cutting torch while running in a running direction above a cutting table on which the material to be processed can be placed. In addition, a large cutting device is provided with an operating deck and allows an operator to operate the cutting device while moving along with the cutting device.

In a gate-type movable laser cutting device such as that described in Patent Document 1, a cover is mounted to cover a cutting head equipped with a cutting torch in order to prevent light of a laser beam emitted from the cutting torch toward a material to be processed from leaking out.

Furthermore, such a cutting device generally requires maintenance work such as cleaning of the cutting head and adjustment of an optical axis of the laser beam emitted from the cutting torch.

### CITATION LIST

### Patent Document

Patent Document 1: Japanese Unexamined Patent Application, First Publication No. 2011-121107

### SUMMARY OF INVENTION

### Technical Problem

However, when the maintenance work is performed, the cutting device as disclosed in Patent Document 1 requires the operator to step down from the operating deck for operating the cutting device, move over a cutting cutting table, open and close the cover, and approach the cutting head inside the cover. At this time, there is a difference in height between the operating deck and the cutting table with respect to the operator. Therefore, there was a problem that when the operator moves on the operating deck or the cutting table, it is burdensome for the operator to get on and off the operating deck and time is taken for moving around. In some cases, the operator may need to get on and off the operating deck or the cutting table multiple times to perform the maintenance work, which puts an even greater strain on the operators' physical strength.

In addition, the cover that covers the cutting head is heavy. Therefore, there is a problem such as the time required for the operator to open and close the cover, and the strain put on the operator when lifting it. Furthermore, when the maintenance work is performed on the cutting table, there is a risk of falling over while moving or hitting one's head on the cover when the cover is open.

The present invention has been made in consideration of the above circumstances, and an object thereof is to provide a cutting machine that allows daily maintenance to be easily performed without entering a dangerous cutting space, thereby improving safety.

### Solution to Problem

In order to solve the above problems, the present invention proposes the following means.

The cutting machine according to the first aspect of the present invention includes a cutting table on which a material to be processed is placed; a cutting machine body including a running carriage configured to be movable in a running direction along a horizontal plane on an upper side of the cutting table, a movement mechanism configured to move in the running direction together with the running carriage and to be movable in a vertical direction and in a lateral direction intersecting with the running direction on the horizontal plane in a cutting space on the upper side of the cutting table, a body cover portion configured to cover the cutting space, and a cutting head positioned in the cutting space and supported by the movement mechanism to cut the material to be processed; an operating deck unit provided on one side in the lateral direction with respect to the cutting machine body and on which a person rides; and an operating unit provided in an external space on the upper side of the operating deck unit and configured to operate the cutting machine body, wherein the operating deck unit includes an opening and closing door on the other side in the lateral direction, the opening and closing door separating the cutting space from the external space.

### ADVANTAGEOUS EFFECTS OF INVENTION

According to the cutting machine of the present invention, it is possible to provide a cutting machine that allows daily maintenance to be easily performed without entering a dangerous cutting space, thereby improving safety.

### BRIEF DESCRIPTION OF DRAWINGS

FIG. 1 A perspective view showing a cutting machine according to an embodiment of the present invention.

FIG. 2 A front view schematically showing the cutting machine.

FIG. 3 A plan view schematically showing the cutting machine.

FIG. 4 A side view schematically showing the cutting machine.

FIG. 5 An enlarged perspective view of the near side of the cutting machine.

FIG. 6 An enlarged front view of the near side of the cutting machine.

FIG. 7 An enlarged plan view of the near side of the cutting machine.

FIG. 8 An enlarged side view of the cutting machine with an opening and closing door slid to open at the near side thereof.

FIG. 9 An enlarged side view of the cutting machine with the opening and closing door slid to be closed at the near side thereof.

FIG. 10 A view showing a state in which an operator is working on an operating deck of the cutting machine.

FIG. 11 A view showing a state in which the operator is working on the operating deck of the cutting machine while the opening and closing door is open.

FIG. 12 A view showing another modified example of the cutting machine.

### DESCRIPTION OF EMBODIMENTS

### One Embodiment

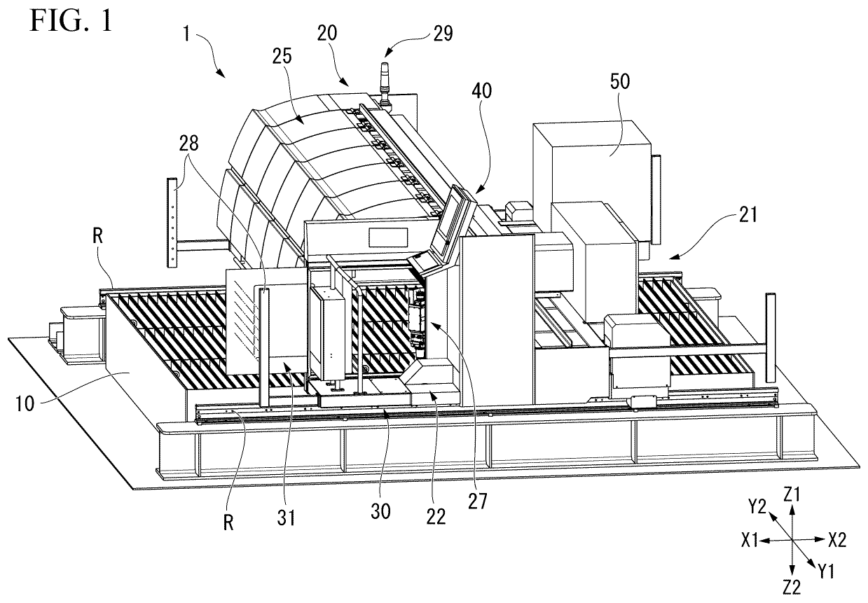

One embodiment of the present invention will be described with reference to FIGS. 1 to 11. In addition, in embodiments and modified examples described below, the same reference numerals will be used to designate corresponding configurations, and descriptions of overlapping portions may be omitted. Furthermore, in the following description, expressions indicating relative or absolute arrangement, such as “parallel,” “orthogonal,” “center,” and “coaxial,” not only indicate such an arrangement strictly, but also indicate a state in which there is a relative displacement with a tolerance or an angle or distance to an extent that the same function is obtained.

### [Cutting Machine 1]

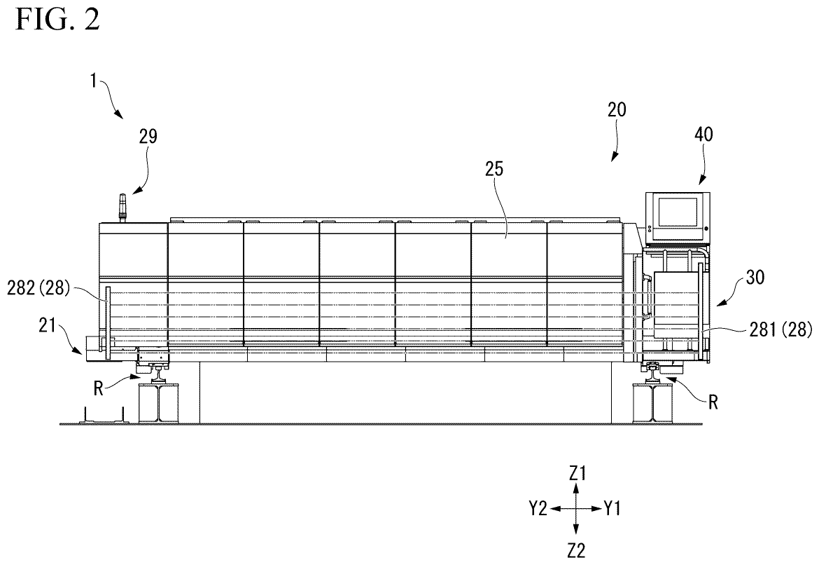

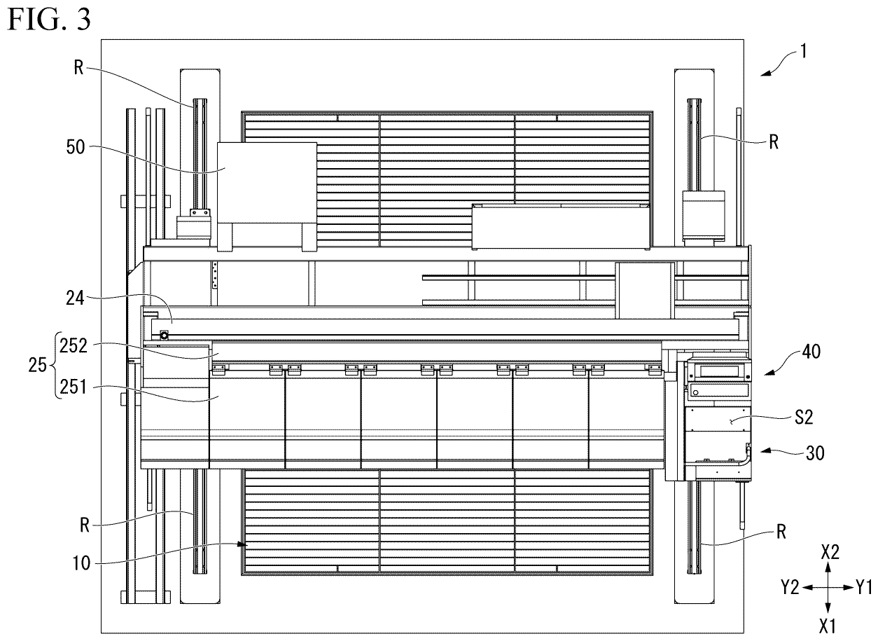

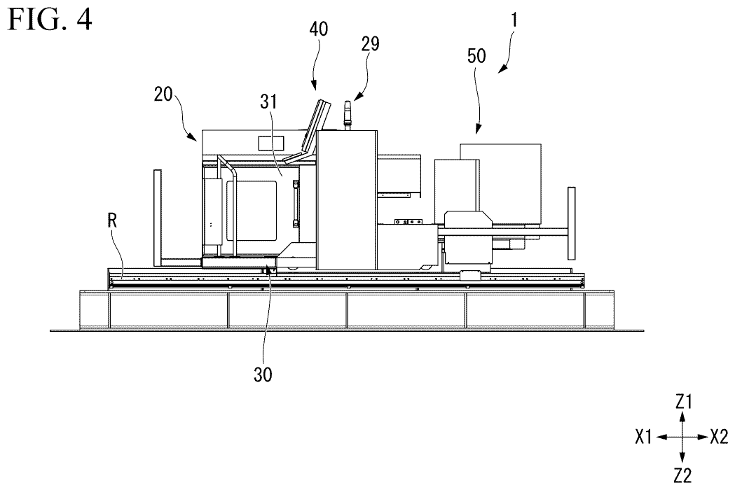

FIG. 1 is a perspective view schematically showing a cutting machine 1 according to one embodiment of the present invention. FIG. 2 is a front view schematically showing the cutting machine 1. FIG. 3 is a plan view schematically showing the cutting machine 1. FIG. 4 is a side view schematically showing the cutting machine 1.

The cutting machine 1 is a device that cuts a material to be processed such as a steel plate placed on a front surface of a cutting table 10. In this embodiment, the cutting machine 1 is a gate-type movable laser cutting machine.

In the following description of the cutting machine 1, a vertical direction is defined as an up-down direction Z. In the up-down direction Z, the front surface side of the cutting table 10 is defined as the upper side Z1, and the back surface side of the cutting table 10 is defined as the lower side Z2. A direction perpendicular to the up-down direction Z and in which the cutting machine 1 runs is defined as a running direction X. In the running direction X, a direction in which the cutting machine 1 advances is referred to as the front side (the forward side) X1, and the side opposite to the front side X1 in which the cutting machine 1 advances backward is referred to as the rearward side (the backward side) X2. A direction perpendicular to the up-down direction Z and the running direction X is defined as a lateral direction Y. In the lateral direction Y, the near side is defined as the near side Y1, and the side opposite to the near side Y1 is defined as the inner side Y2. A surface along the running direction X and the lateral direction Y is defined as a horizontal plane (hereinafter, simply referred to as a horizontal plane).

As shown in FIG. 1, the cutting machine 1 includes a cutting table 10, a cutting machine body 20, an operating deck 30, an operating unit 40, and a control unit 50.

### [Cutting Table 10]

The cutting table 10 is formed, for example, in a rectangular shape along the horizontal plane and is positioned on the ground. The cutting table 10 allows a material to be processed to be placed on the upper side Z1 which is the front surface side. The material to be processed is cut by a cutting torch 272 mounted in the cutting head 27 of the cutting machine 1 in a cutting space S1 formed on the upper side Z1 of the cutting table 10. In this embodiment, the cutting space S1 is a space in which the cutting torch 272 radiates a laser beam to form a cut groove in the material to be processed. In this embodiment, the material to be processed is a steel plate, but is not particularly limited thereto, and may be a plate-shaped member made of a different material, or may be something other than a plate, for example, a block state or a pipe shape.

### [Cutting Machine Body 20]

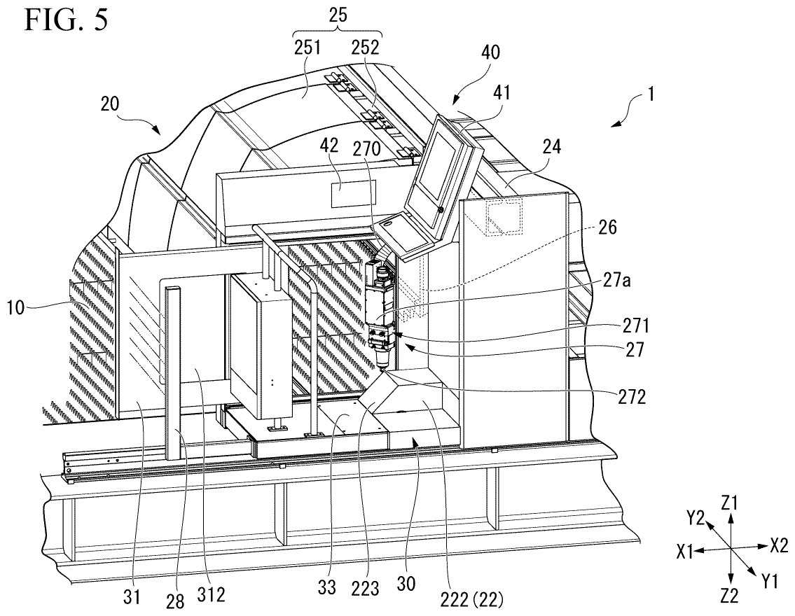

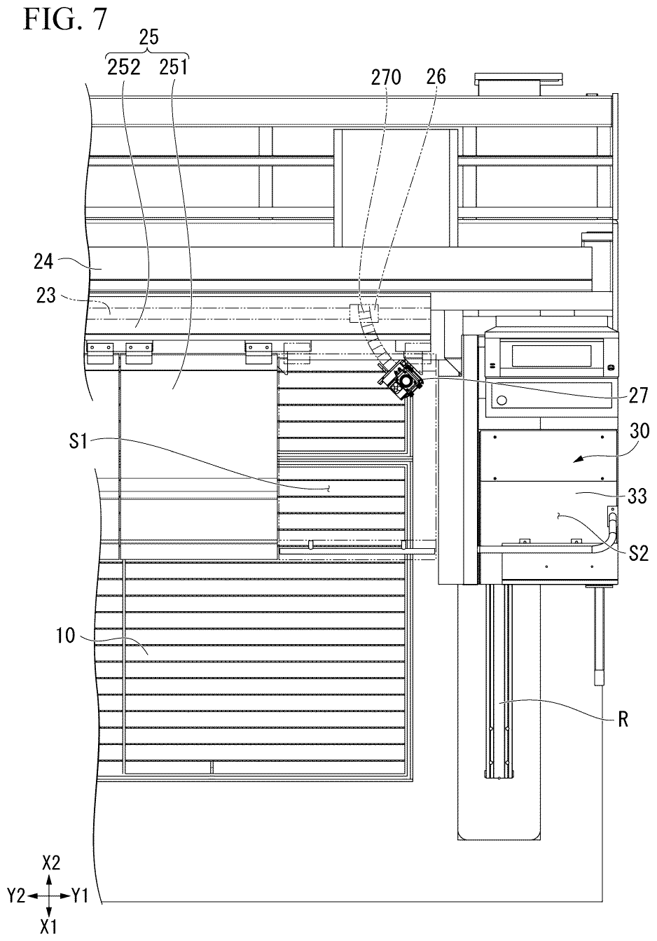

The cutting machine body 20 is configured to be able to run on rails R positioned in the running direction X on the upper side Z1 of the cutting table 10. The rails R are mounted on both side surfaces of the cutting table 10 in the lateral direction Y, as shown in FIGS. 1 to 3. The cutting machine body 20 includes a running carriage 21, a running drive unit 22, a lateral rail 23 (refer to FIG. 7), an upper stay 24 (refer to FIG. 3), a light-shielding cover portion (a body cover portion) 25, a movement mechanism 26 (refer to FIG. 5), a cutting head 27, an area sensor 28, and an warning unit 29.

### [Running Carriage 21]

The running carriage 21 is, for example, a gate-shaped frame that is movable in the running direction X on the upper side Z1 of the cutting table 10. The running carriage 21 is a part that serves as a base of the cutting machine 1. The running carriage 21 is placed on rails R on both sides in the lateral direction Y by saddles and girders which are not shown.

### [Running Drive Unit (Drive Unit) 22]

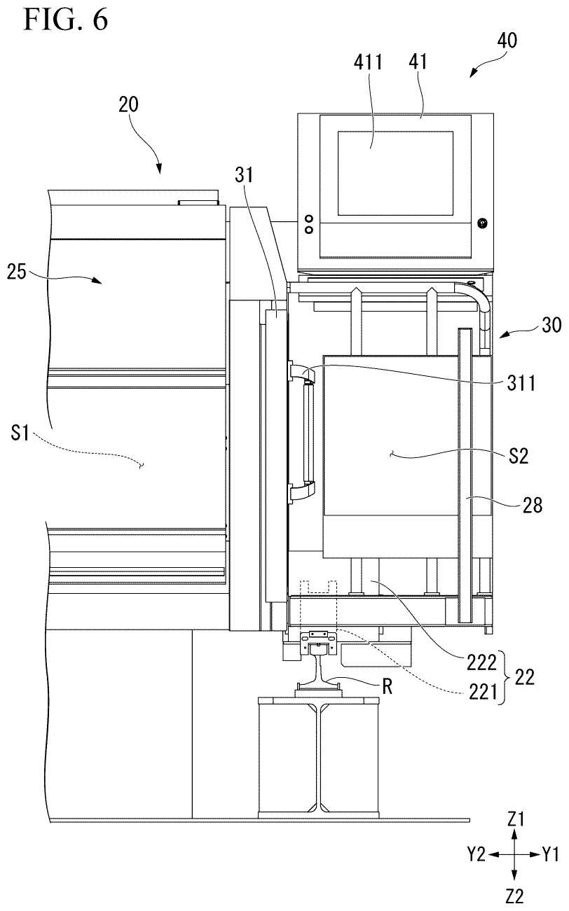

FIG. 5 is an enlarged perspective view of the near side Y1 of the cutting machine 1. FIG. 6 is an enlarged front view of the near side Y1 of the cutting machine 1.

As shown in FIG. 5, the running drive unit (drive unit) 22 is configured to be driven by a running motor (not shown) so as to be capable of running along the rails R in a desired direction at a desired speed. As shown in FIG. 6, the running drive unit 22 includes a wheel 221 and a wheel cover portion 222.

As shown in FIG. 6, the wheel 221 rotates on the rail R positioned in the running direction X and thus moves the entire cutting machine body 20 in the running direction X. In addition, the wheel cover portion 222 covers the wheel 221 from the upper side Z1 in the up-down direction Z.

As shown in FIG. 5, the wheel cover portion 222 has a cutout portion 223 at a tip end thereof provided on the front side X1 in the running direction X. The cutout portion 223 is cut out so as to incline toward the front side X1 from the upper side Z1 to the lower side Z2 in the up-down direction Z.

The running drive unit 22 is positioned on a pair of rails R, and has a drive motor (not shown). The running drive unit 22 is configured to be able to move the running carriage 21 in the running direction X by the control unit 50 which will be described below.

### [Lateral Rail 23]

FIG. 7 is an enlarged plan view of the near side Y1 of the cutting machine 1.

As shown in FIG. 7, the lateral rail 23 is mounted on the upper side Z1 of the running carriage 21 and extends in the lateral direction Y. The movement mechanism 26 serving as a lateral carriage is mounted on the lateral rail 23.

### [Upper Stay 24]

The upper stay 24 is provided on the upper side Z1 with respect to the lateral rail 23. As shown in FIG. 7, the upper stay 24 is positioned on the rear side X2 with respect to the cutting space S1 in the running direction X, and extends in the lateral direction Y. The upper stay 24 is connected to the light-shielding cover portion 25 at an upper surface thereof and supports the light-shielding cover portion 25.

### [Light-Shielding Cover Portion (Body Cover Portion) 25]

The light-shielding cover portion (the body cover portion) 25 is formed, for example, by processing a metal plate. As shown in FIGS. 1 to 3, the light-shielding cover portion 25 is provided on the upper side Z1 of the running carriage 21 and configured to cover the cutting space S1. The light-shielding cover portion 25 is configured to separate the cutting space S1 from an external space S2 located outside the cutting space S1. The light-shielding cover portion 25 includes a rotating cover portion 251 and a fixed cover portion 252.

As shown in FIGS. 3 and 5, when seen in the lateral direction Y (in side view), the rotating cover portion 251 is formed from the upper side Z1 of the cutting torch 272 to the front side X1 in the running direction X, and bulges toward the external space S2 so that the cutting space S1 expands. The rotating cover portion 251 is configured to cover the front side X1 and the inner side Y2 in the lateral direction Y of the movement mechanism 26 and the cutting head 27.

The fixed cover portion 252 extends in the lateral direction Y and is connected to the rotating cover portion 251 and the upper stay 24. The rotating cover portion 251 for example, is connected to the fixed cover portion 252 on the upper side Z1 of the lateral rail 23 provided on the running carriage 21, via a hinge structure. The hinge structure, for example, allows the rotating cover portion 251 to be opened and closed by rotating about a connecting portion in a Y-axis direction as a rotation axis.

In addition, the light-shielding cover portion 25 is mounted so as to hang down to the lower side Z2 of the running carriage 21 in the up-down direction Z. A plurality of rotating cover portions 251 are arranged in the lateral direction Y, and are connected to the fixed cover portion 252 so that each can be opened and closed individually.

### [Movement Mechanism 26]

The movement mechanism 26 is placed on the running carriage 21 and moves in the running direction X together with the running carriage 21. In addition, as shown in FIG. 7, the movement mechanism 26 is mounted on the lateral rail 23 and is driven by a drive unit (not shown) so as to be movable in the lateral direction Y in the cutting space S1 on the upper side Z1 of the cutting table 10. Furthermore, the movement mechanism 26 is provided with a lifting bracket (not shown) and is configured to be movable in the up-down direction Z as well. The movement mechanism 26 can move at a desired speed. As shown in FIG. 7, the movement mechanism 26 supports the cutting head 27 via an arm 270 mounted on the front side X1.

### [Cutting Head 27]

As shown in FIG. 7, the cutting head 27 is positioned in the cutting space S1 on the upper side Z1 of the cutting table 10 and cuts a material to be processed that is placed on the cutting table 10. The cutting head 27 is supported by the movement mechanism 26 via the arm 270. As shown in FIG. 7, the arm 270 is mounted so as to extend to the front side X1 when seen from the upper side (in plan view) Z1 and to face slightly to the near side Y1.

As shown in FIG. 1, the cutting head 27 can be moved in the running direction X by the running carriage 21 with respect to the cutting table 10, and can also be moved in the lateral direction Y and the up-down direction Z by the movement mechanism 26.

In this embodiment, the cutting head 27 has side surfaces in the running direction X and the lateral direction Y, and is formed in a generally rectangular prism shape that extends in the up-down direction Z. The cutting head 27 has an adjustment screw unit 271 on a front surface (a side surface) 27a on the front side X1 in the running direction X for adjusting a cutting position of a material to be processed. Specifically, the adjustment screw unit 271 can adjust the cutting position of the material to be processed by performing adjustment of an optical axis of a laser beam emitted from the cutting torch 272 mounted on the lower side Z2 of the cutting head 27.

Further, as shown in FIG. 5, in a state in which the cutting head 27 is closest to an opening and closing door 31 on the near side Y1 with respect to the cutting head 27 in the cutting space S1, it is preferable for an operator to orient a front surface 27a of the cutting head 27 toward the opening and closing door 31 at an angle that makes it easy to maintain the cutting torch 272 from the operating deck 30 with a central axis of the cutting head 27 in the up-down direction Z as a rotation axis. Further, as shown in FIG. 5, the cutting torch 272 is mounted in the cutting head 27.

As shown in FIG. 5, the cutting torch (a laser torch) 272 is mounted on the lower side Z2 of the cutting head 27. The cutting torch 272 is, for example, a laser torch that cuts a material to be processed by laser cutting. The cutting torch 272 is configured such that the tip end side of a cylindrical portion on the lower side Z2 is formed into a substantially conical shape and a nozzle hole (not shown) is opened at the tip end, and is configured to inject an assist gas and to radiate a laser beam generated by a fiber laser oscillator (not shown) from the nozzle hole to form a cut groove in the material to be processed. The cutting torch 272 can be moved together with the cutting head 27 on the cutting table 10 in the running direction X and the lateral direction Y. Further, the cutting torch 272 can be moved in the up-down direction Z to change a height as desired, and can move along a cutting shape to be formed in the material to be processed. Furthermore, an inclination of the cutting torch 272 with respect to the up-down direction Z can be changed as necessary. The cutting torch 272 is not limited to the laser torch, and may be a plasma torch or a gas torch.

### [Area Sensor 28]

As shown in FIG. 1, the area sensor 28 is provided slightly on the front side X1 of the light-shielding cover portion 25. As shown in FIG. 2, the area sensor 28 includes a plurality of light projecting units 281 mounted on a pole that extends to the upper side Z1 in the up-down direction Z on the near side Y1 in the lateral direction Y, and light receiving units 282 mounted on a pole that extends to the upper side Z1 in the up-down direction Z on the inner side Y2 in the lateral direction Y, the same number as the light projecting units 281. The area sensor 28 emits a plurality of light beams from the light projecting units 281 to the light receiving units 282 to form a detection region along a vertical plane perpendicular to the horizontal plane and defined by the up-down direction Z and the lateral direction Y. The number of light projecting units 281 and light receiving units 282 is not particularly limited.

The area sensor 28 detects an object that enters or blocks the detection region. When the area sensor 28 detects an object, the area sensor 28 transmits a detection signal to the control unit 50. Furthermore, when the area sensor 28 returns from a state in which it has detected an object that enters or blocks the detection region to an original non-detection state, it transmits a non-detection signal to the control unit 50.

### [Warning Unit 29]

The warning unit 29 is a warning light positioned to protrude from the cutting machine body 20 to the upper side Z1. The warning unit 29 informs a user of danger by turning on the warning light when a signal is received from the control unit 50. The warning unit 29 may further include an audio means such as an alarm.

### [Operating Deck (Operating Deck Unit) 30]

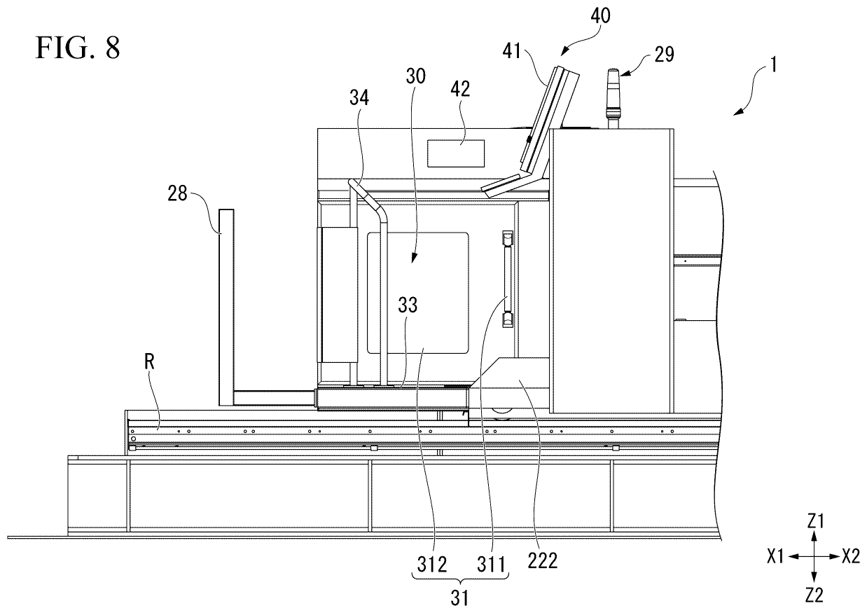

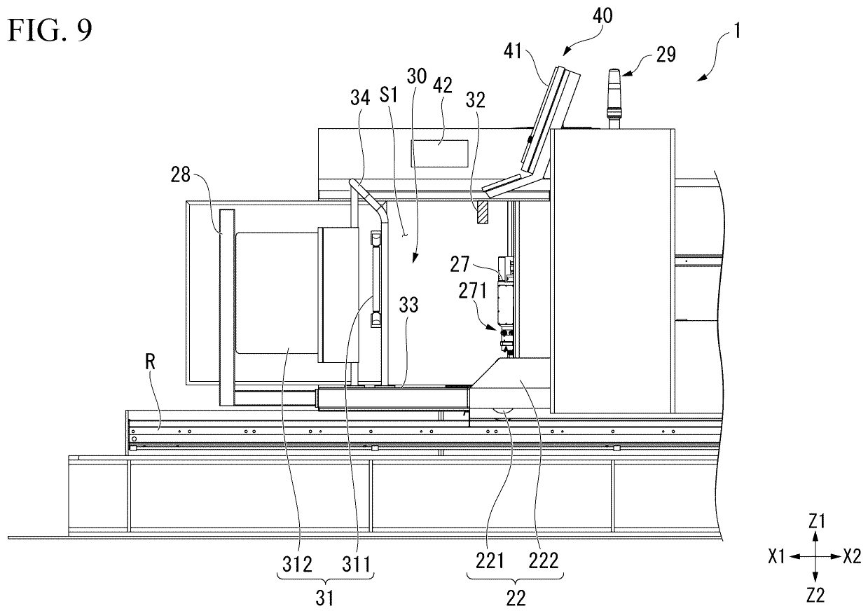

FIG. 8 is an enlarged side view of the cutting machine 1 with the opening and closing door 31 slid to open on the near side Y1 of the cutting machine 1. FIG. 9 is an enlarged side view of the cutting machine 1 with the opening and closing door 31 slid to be closed on the near side Y1 of the cutting machine 1.

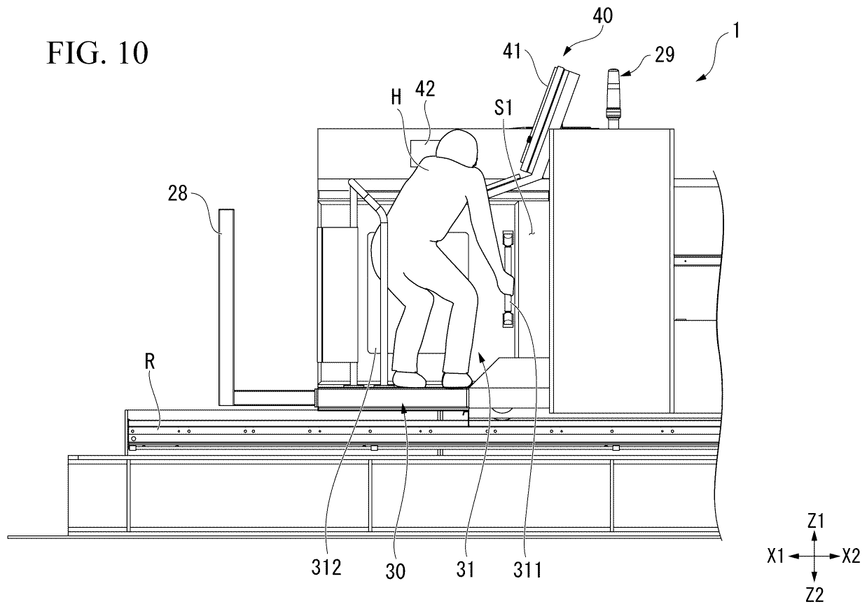

The operating deck (the operating deck unit) 30 is a deck on which an operator (a person) H (refer to FIG. 10) can ride. The operating deck 30 is provided on the near side (the one side) Y1 of the cutting machine body 20 in the lateral direction Y, as shown in FIG. 1. In this embodiment, as shown in FIG. 7, the operating deck 30 has a size that allows about one worker to get into the external space S2 on the upper side Z1 of a bottom plate portion 33 on which the operator H rides. However, there is no particular limitation on the size of the operating deck 30. As shown in FIG. 5, the wheel cover portion 222 is positioned on a part of the bottom plate portion 33 of the operating deck 30 so as to protrude to the upper side Z1. The wheel cover portion 222 has the cutout portion 223 at a tip end thereof on the front side X1 in the running direction X and ensures the external space S2 on the upper side Z1 of the bottom plate portion 33. As shown in FIGS. 8 and 9, the operating deck 30 includes an opening and closing door 31, an electromagnetic lock 32, and a handrail 34.

The opening and closing door 31 is provided on the inner side (the other side) Y2 of the operating deck 30 in the lateral direction Y. The opening and closing door 31 is provided so as to be openable and closable by sliding in the running direction X. The opening and closing door 31 is formed in a substantially rectangular shape. The opening and closing door 31 is positioned so that an inner surface thereof facing the cutting space S1 in a closed state is in contact with an end portion of the light-shielding cover portion 25 positioned on the near side Y1 among the plurality of light-shielding cover portions 25, and separates the cutting space S1 from the external space S2, as in the light-shielding cover portion 25.

Furthermore, when the opening and closing door 31 is in a closed state, the cutting head 27 is operated by the operating unit 40 in the cutting space S1 to approach the opening and closing door 31. Then, in the closest state, the cutting head 27 is positioned so as to overlap the opening and closing door 31 when seen in the lateral direction Y.

When the opening and closing door 31 is opened by sliding to the front side X1 in the running direction X, the opening and closing door 31 communicates the cutting space S1 with the external space S2. At that time, a part of the front side X1 of the opening and closing door 31 is positioned in the detection area of the area sensor 28. As shown in FIG. 8, the opening and closing door 31 has a maintenance window 312 at a center portion thereof and a handle 311 on the rear side X2 of the maintenance window 312. Since the handle 311 is provided on the opening and closing door 31, the operator H can easily place his/her hand on the handle 311 and can slide the opening and closing door 31 when the opening and closing door 31 is opened or closed.

The maintenance window 312 is, for example, a semi-transparent special film through which it is difficult for laser light to pass and allows objects to be confirmed. The maintenance window 312 is formed in a rectangular shape along an outer edge of the opening and closing door 31. In a state in which the opening and closing door 31 is closed, the operator H can visually check a position of the cutting head 27 positioned in the cutting space S1 of the cutting machine body 20 through the maintenance window 312. However, a material of the maintenance window 312 is not particularly limited as long as it is made of a material that is difficult for laser light to pass through and allows the operator H to check the cutting space S1 from the external space S2. Furthermore, the size and the shape of the maintenance window 312 are not particularly limited.

As shown in FIG. 9, the electromagnetic lock (a locking mechanism) 32 is provided near the opening and closing door 31 and locks the opening and closing of the opening and closing door 31. The electromagnetic lock 32 is set to be locked when the opening and closing door 31 is in a closed state. When the electromagnetic lock 32 receives an electromagnetic lock release signal from the control unit 50, the electromagnetic lock 32 is allowed to be released, and the operator H can release the electromagnetic lock 32 by turning a key mounted in the electromagnetic lock 32. The electromagnetic lock 32 is unlocked when the opening and closing door 31 is in an opening state. When the electromagnetic lock 32 receives an electromagnetic lock setting signal from the control unit 50, the electromagnetic lock 32 is allowed to be set, and the operator H can set the electromagnetic lock 32 by turning the key mounted in the electromagnetic lock 32 back to an original position thereof. The electromagnetic lock 32 is released when a power supply to the cutting machine 1 is turned off. The configuration of the electromagnetic lock 32 is not particularly limited, and any conventionally known electromagnetic lock can be used. Further, the locking mechanism for locking the opening and closing of the opening and closing door 31 of the present invention is not limited to the electromagnetic lock 32.

### [Operating Unit 40]

The operating unit 40 can perform an input operation for the cutting machine 1. The operating unit 40 includes a body operating unit 41 and a maintenance operating unit 42.

The body operating unit 41 is provided on the rear side X2 of the external space S1 formed on the upper side Z1 of the operating deck 30, and operates the cutting machine body 20. As shown in FIG. 7, the body operating unit 41 is provided slightly on the rear side X2 with respect to the cutting head 27. As shown in FIG. 6, the body operating unit 41 can perform the input operation using a mouse, a keyboard, or operation buttons, or the like which are separate from a display unit 411 in accordance with information displayed on the display unit 411. The body operating unit 41 is operated by the operator to input information necessary for a cutting work, or the like. The body operating unit 41 can also input a movement instruction to move the cutting head 27 in a desired direction. The input movement instruction is transmitted to the control unit 50. The body operating unit 41 may be a touch panel.

The maintenance operating unit 42 is, for example, a touch panel mounted in a rectangular liquid crystal monitor provided on the front side X1 of the body operating unit 41. The maintenance operating unit 42 is provided on the upper side Z1 of the opening and closing door 31. The maintenance operating unit 42 is capable of inputting operations for setting and releasing the electromagnetic lock 32 mounted on the opening and closing door 31. The input electromagnetic lock setting and release information is transmitted to the control unit 50. In this way, the maintenance operating unit 42 can also operate the locking of the opening and closing door 31 by the electromagnetic lock 32.

The maintenance operating unit 42 may display an operation state of the cutting machine 1 on the display unit of the touch panel that is integrally formed with the maintenance operating unit 42. The body operating unit 41 and the maintenance operating unit 42 may be integrally formed.

### [Control Unit 50]

The control unit 50 is a device (a computer) that reads a program, data, or information obtained from an external source and controls the cutting machine 1. The control unit 50 may be, for example, a conventionally known computer.

The control unit 50 is provided on the rear side X2 with respect to the cutting machine body 20. For example, the control unit 50 can control the cutting machine body 20 that forms the cutting space S1 to stop a cutting operation when the control unit 50 receives an object detection signal from a sensor (not shown) or the like mounted on the cutting machine body 20 to surround the cutting space S1. With such a configuration, the cutting space S1 and the external space S2 can be electrically separated to ensure a safety area for the operator. The control unit 50 is also configured to be able to communicate with external devices wirelessly or via wires using a communication unit (not shown).

Specifically, when the control unit 50 receives an instruction to move the cutting head 27 from the body operating unit 41, the control unit 50 controls the drive unit and the lifting bracket (not shown) that drive the running drive unit 22 and the movement mechanism 26. That is, the control unit 50 can control the cutting head 27 to be movable in the running direction X, the lateral direction Y and the up-down direction Z.

Furthermore, when the control unit 50 acquires a detection signal from the area sensor 28, the control unit 50 can temporarily stop the operation of the cutting machine body 20. Furthermore, when the control unit 50 receives a non-detection signal from the area sensor 28, the control unit 50 can release the temporarily stopped state of the operation of the cutting machine body 20 and make it operable.

In addition, when an operation input is made from the maintenance operating unit 42 to release the electromagnetic lock 32 mounted on the opening and closing door 31, the control unit 50 confirms that the operation of the cutting machine 1 has been stopped or temporarily stopped. When the operation of the cutting machine 1 is stopped or temporarily stopped, the control unit 50 transmits an electromagnetic lock release signal to the electromagnetic lock 32. When the cutting machine 1 is being operated by a program or manually, the control unit 50 does not transmit the electromagnetic lock release signal to the electromagnetic lock 32. In other words, the operator H cannot open the opening and closing door 31. The control unit 50 may be controlled so that when the operation of the cutting machine 1 is stopped or temporarily stopped, the electromagnetic lock release signal is sent to the electromagnetic lock 32 even when no operation input is made from the maintenance operating unit 42 to release the electromagnetic lock 32 mounted on the opening and closing door 31.

In addition, when an operation input is received from the maintenance operating unit 42 to set the electromagnetic lock 32 mounted on the opening and closing door 31, the control unit 50 checks whether the opening and closing door 31 is securely closed by an interlock such as a sensor. When the opening and closing door 31 is securely closed, the control unit 50 transmits the electromagnetic lock setting signal to the electromagnetic lock 32. When the opening and closing door 31 is not securely closed, the control unit 50 does not transmit the electromagnetic lock setting signal to the electromagnetic lock 32. At this time, the control unit 50 can also issue a warning or alarm via the warning unit 29.

Furthermore, when the opening and closing door 31 is unintentionally opened or closed while the cutting machine 1 is in operation, the control unit 50 can temporarily stop the cutting machine 1 and can issue a warning or alarm via the warning unit 29.

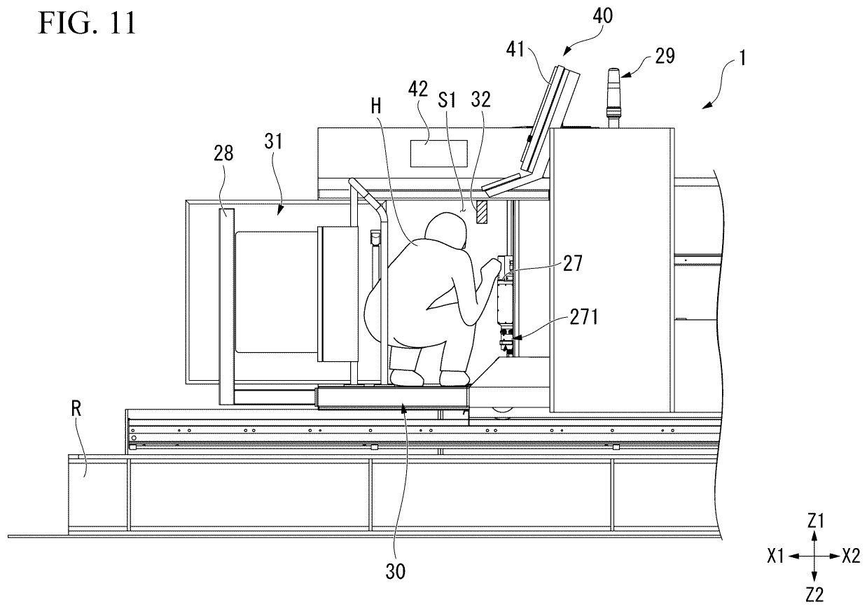

Next, the operation of the cutting machine 1 according to this embodiment will be described with reference to FIGS. 10 and 11.

FIG. 10 is a diagram showing a state in which the operator H is working on the operating deck 30 of the cutting machine 1. FIG. 11 is a diagram showing a state in which an operator H is working on the operating deck 30 of the cutting machine 1 while the opening and closing door 31 is open. First, the operator H completes the cutting operation of the cutting machine 1 and starts the maintenance operation of the cutting machine 1 (start step). Next, the control unit 50 performs a moving step.

### <Moving Step>

In the moving step, the operator performs an operation input on the body operating unit 41 to move the cutting head 27, for example, to the near side Y1 in the lateral direction Y. The body operating unit 41 transmits the input information to the control unit 50. Then, the control unit 50 moves the cutting head 27 to the near side Y1 in the lateral direction Y in accordance with an instruction. The cutting head 27 stops in a state in which it is closest to the opening and closing door 31 in the cutting space S1. Next, the control unit 50 performs a lock release step.

### <Lock Release Step>

In the lock release step, the operator performs an operation input to the maintenance operating unit 42 for releasing the electromagnetic lock 32 mounted on the opening and closing door 31. The control unit 50 then confirms that the operation of the cutting machine 1 has been stopped or temporarily stopped. When the operation of the cutting machine 1 is stopped or temporarily stopped, the control unit 50 transmits an electromagnetic lock release signal to the electromagnetic lock 32. When the electromagnetic lock 32 receives the electromagnetic lock release signal, the electromagnetic lock 32 is allowed to be released, and the operator H can release the electromagnetic lock 32 by turning the key mounted in the electromagnetic lock 32. The control unit 50 may be controlled so that when the operation of the cutting machine 1 is stopped or temporarily stopped, the electromagnetic lock release signal is sent to the electromagnetic lock 32 even when no operation input is made from the maintenance operating unit 42 to release the electromagnetic lock 32 mounted on the opening and closing door 31.

When the cutting machine 1 is operating, the control unit 50 does not transmit the electromagnetic lock release signal to the electromagnetic lock 32.

Then, as shown in FIGS. 10 and 11, while the operator gets on the operating deck 30, the operator holds the handle 311 of the opening and closing door 31 and slides it to the front side X1 in the running direction X to open the opening and closing door 31. At this time, a part of the front side X1 of the opening and closing door 31 is positioned in the detection area of the area sensor 28. When the area sensor 28 detects an object, the area sensor 28 transmits a detection signal to the control unit 50. Next, the control unit 50 performs a stopping step.

### <Stopping Step>

In the stopping step, as shown in FIG. 11, when an object is detected by the area sensor 28 and a detection signal is transmitted to the control unit 50, the control unit 50 acquires the detection signal and can temporarily stop the operation of the cutting machine body 20.

In this state, the operator can perform a maintenance work through the opening and closing door 31. When the maintenance work is completed, the operator gets on the operating deck 30, grasps the handle 311 of the opening and closing door 31, and slides it to the rear side X2 in the running direction X to close the opening and closing door 31, as shown in FIGS. 11 to 10. At this time, a part of the front side X1 of the opening and closing door 31 is out of the detection area of the area sensor 28. When the area sensor 28 returns from the state in which it has detected an object entering or blocking the detection area to the original non-detection state, the area sensor 28 transmits a non-detection signal to the control unit 50. Then, the operator performs an operation input to the maintenance operating unit 42 for setting the electromagnetic lock 32 mounted on the opening and closing door 31. Next, the control unit 50 performs a stop release step and a lock setting step.

### <Stop Release Step>

When the control unit 50 receives the no-detection signal from the area sensor 28, the control unit 50 can release the temporarily stopped state of the operation of the cutting machine body 20 and make it operable again.

### <Lock Release Step>

Furthermore, when the control unit 50 acquires electromagnetic lock setting information from the maintenance operating unit 42, the control unit 50 checks whether the opening and closing door 31 is securely closed by an interlock using a sensor or the like. When the opening and closing door 31 is securely closed, the control unit 50 transmits an electromagnetic lock setting signal to the electromagnetic lock 32. When the electromagnetic lock 32 acquires the electromagnetic lock setting signal, the electromagnetic lock 32 is allowed to be set, and the operator H can set the electromagnetic lock 32 by turning the key mounted in the electromagnetic lock 32 back to the original position thereof. When the opening and closing door 31 is not securely closed, the control unit 50 does not transmit the electromagnetic lock setting signal to the electromagnetic lock 32.

When all steps are completed, the operator finishes the maintenance work.

In this embodiment, the cutting machine 1 includes the opening and closing door 31 that separates the cutting space S1 from the external space S2. In the state in which the opening and closing door 31 is closed, the cutting head 27 is positioned at a position at which it overlap the opening and closing door 31 in the closest state when seen in the lateral direction Y. Therefore, the operator H can easily perform the maintenance work on the cutting head 27 by opening the opening and closing door 31 while riding in the external space S2 on the upper side Z1 of the bottom plate portion 33 provided on the operating deck 30.

Further, in this embodiment, the opening and closing door 31 is provided so as to communicate the cutting space S1 with the external space S2 when it is opened by sliding in the running direction X. Therefore, the opening and closing door 31 can be opened and closed without interfering with the bottom plate portion 33 of the operating deck 30 on which the operator H rides, and the operator H can easily perform the maintenance work on the cutting head 27 positioned in the cutting space S1 in a space-saving manner.

Further, in this embodiment, the cutting machine 1 includes the electromagnetic lock (the locking mechanism) 32 that locks the opening and closing of the opening and closing door 31. Therefore, the opening and closing door 31 does not open until the cutting operation of the cutting machine 1 is completed or stopped. Therefore, the operator can safely perform the maintenance work while the operation of the cutting machine 1 is completely stopped.

Further, In this embodiment, the cutting machine 1 includes the area sensor 28. The area sensor 28 detects an object that enters the detection area. When the opening and closing door 31 is opened by sliding to the front side X1 in the running direction X, a part of the front side X1 of the opening and closing door 31 is positioned in the detection area of the area sensor 28. When the area sensor 28 transmits a detection signal to the control unit 50, the control unit 50 can temporarily stop the operation of the cutting machine 1. Therefore, in addition to the electromagnetic lock (the locking mechanism) 32, the operator H can perform the maintenance work more safely. Furthermore, even when the electromagnetic lock 32 fails, the control unit 50 can temporarily stop the operation of the cutting machine 1 using the area sensor 28, and thus can be used as a backup function for the electromagnetic lock 32.

In addition, in this embodiment, the opening and closing door 31 of the cutting machine 1 includes the maintenance window 312 through which the position of the cutting head 27 positioned in the cutting space S1 of the cutting machine body 20 can be visually confirmed in a state in which the opening and closing door 31 is closed. By checking this maintenance window 312, the operator H can easily visually check the position of the cutting head 27 positioned in the cutting space S1 from the external space S2 and can adjust the position of the cutting head 27.

In this embodiment, the maintenance operating unit 42 provided on the operating unit 40 of the cutting machine 1 is provided on the front side X1 with respect to the body operating unit 41 in the running direction X and on the upper side Z1 of the opening and closing door 31. The body operating unit 41 is provided on the rear side X2 of the operating deck 30 and the cutting head 27. Therefore, while the operator H is in the external space S2 on the upper side ZI of the operating deck 30, the operator H can easily perform the maintenance work such as cleaning of the cutting head 27 in a shorter time than before. Furthermore, since the operator H does not need to get off the operating deck 30 and to move onto the unstable cutting table 10, a workload of the operator H during the maintenance work and the time required for movement are reduced. It is also possible to eliminate the risk of the operator H falling over or hitting his/her head on the light-shielding cover portion (the body cover portion) 25.

Furthermore, since it is no longer necessary to open and close the light-shielding cover portion 25, which was necessary in the conventional maintenance work, the burden on the operator H can be further reduced.

In addition, in this embodiment, the cutting head 27 of the cutting machine 1 is positioned such that a front surface (a side surface) 27a equipped with the adjustment screw unit 271 faces the opening and closing door 31 in a state in which the cutting head 27 approaches the opening and closing door 31 in the cutting space S1. Therefore, while the operator H is in the external space S2 on the upper side Z1 of the operating deck 30, the operator H can easily clean the cutting head 27, clean optical products such as optical lenses and glass provided on the cutting head 27, and adjust an optical axis of a laser beam emitted from the cutting torch 272 using the adjustment screw unit 271 on the front surface 27a without entering the cutting space S1.

In addition, in this embodiment, the wheel cover portion 222 of the running drive unit 22 provided in the cutting machine 1 has a cutout portion 223 at a tip end thereof on the front side X1 in the running direction X. The wheel cover portion 222 is positioned on a part of the bottom plate portion 33 of the operating deck 30 so as to protrude to the upper side Z1 in order to secure space, but the cutout portion 223 can secure the external space S2 on the upper side ZI of the bottom plate portion 33. Therefore, a space for the operator H to ride can be maximized.

As described above, Although one embodiment of the present invention has been described in detail above with reference to the drawings, the specific configuration is not limited to this embodiment, and design changes and the like that do not deviate from the gist of the present invention are also included. Furthermore, the components shown in the above-described embodiment and the modified example shown below can be combined as appropriate.

### Modified Example

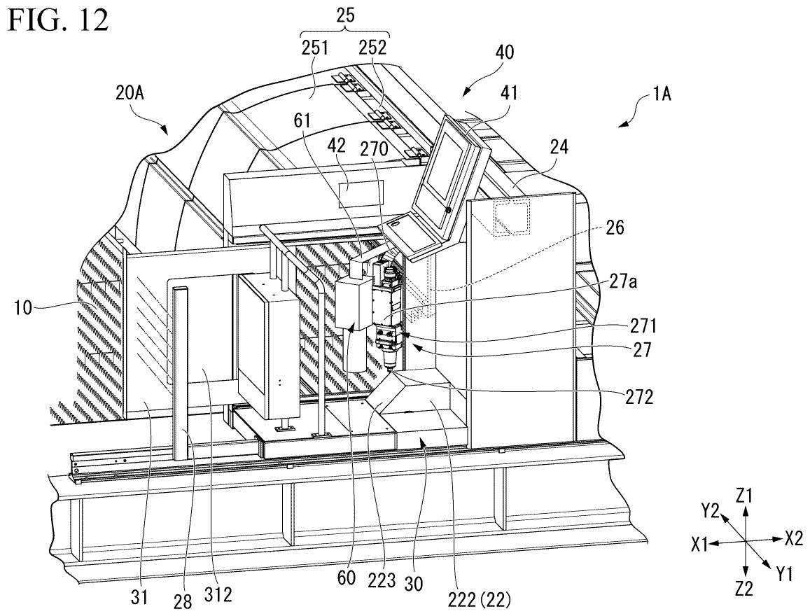

For example, as shown in FIG. 12, a cutting machine body 20A of a cutting machine 1A may further include a marking device 60. The marking device 60 is supported by the movement mechanism 26 together with the cutting head 27 via a stay 61, and is movable in any direction. The marking device 60 is a device capable of printing characters or drawing lines on a material to be processed. The marking device 60 is positioned on the front side X1 with respect to the cutting head 27, and as shown in FIG. 12, it can be positioned in the cutting space SI at a position closest to the opening and closing door 31 at which the operator H can reach out from the external space S2 to perform a maintenance work. Even in this case, the cutting machine 1A can easily be maintained, and optional equipment such as the marking device 60 can be provided.

The control unit of the present invention may be set so as not to transmit the electromagnetic lock release signal to the electromagnetic lock until the cutting head moves to the nearest side in the lateral direction at which the opening and closing door is located. With such a configuration, since the cutting space between the cutting head and the opening and closing door is the narrowest, the operator can easily perform the maintenance work from the external space without providing any gaps to reach out. Also, the control unit may further include storage means such as a ROM, a RAM, and a HDD.

Further, The cutting machine of the present invention may further include an emergency stop switch for opening the opening and closing door in an emergency. By pressing the emergency stop switch, the operator can release the electromagnetic lock (the locking mechanism) in an emergency and can open the opening and closing door.

The cutting machine of the present invention is not limited to a laser cutting machine, and may be any of various conventionally known cutting machines such as a plasma cutting machine or a drill cutting machine. Furthermore, the size of the cutting machine is not particularly limited, and cutting machines of any size may be used.

In any of the above types, according to the cutting machine of the present invention, it is possible to provide a cutting machine that can easily perform daily maintenance without entering a dangerous cutting space, thereby improving safety.

### INDUSTRIAL APPLICABILITY

According to the cutting machine of the present invention, since it is possible to provide a cutting machine that can easily perform daily maintenance without entering a dangerous cutting space, thereby improving safety, the cutting machine can be used industrially.

### REFERENCE SIGNS LIST

1, 1A Cutting machine
10 Cutting table
20, 20A Cutting machine body
21 Running carriage
22 Running drive unit (drive unit)
221 Wheel
222 Wheel cover portion
23 Lateral rail
24 Upper stay
25 Light-shielding cover portion (body cover portion)
26 Movement mechanism
27 Cutting head
27a Front surface (side surface)
271 Adjustment screw unit
272 Cutting torch
28 Area sensor
30 Operating deck (operating deck unit)
31 Opening and closing door
312 Maintenance window
32 Electromagnetic lock (locking mechanism)
33 Bottom plate portion
40 Operating unit
41 Body operating unit
42 Maintenance operating unit
50 Control unit
60 Marking device
H Operator
S1 Cutting space
S2 External space

1. A cutter comprising:
a cutting table on which a material to be processed is placed;
a cutting machine body including a running carriage configured to be movable in a running direction along a horizontal plane on an upper side of the cutting table, a movement mechanism configured to move in the running direction together with the running carriage and to be movable in a vertical direction and in a lateral direction intersecting with the running direction on the horizontal plane in a cutting space on the upper side of the cutting table, a body cover portion configured to cover the cutting space, and a cutting head positioned in the cutting space and supported by the movement mechanism to cut the material to be processed;
an operating deck unit provided on one side in the lateral direction with respect to the cutting machine body and on which a person rides; and
an operating unit provided in an external space on the upper side of the operating deck unit and configured to operate the cutting machine body,
wherein the operating deck unit includes an opening and closing door on the other side in the lateral direction, the opening and closing door separating the cutting space from the external space.

2. The cutting machine according to claim 1, wherein the cutting head is positioned in the cutting space at a position at which it overlaps the opening and closing door in a state in which it has approached the opening and closing door when seen in the lateral direction.

3. The cutting machine according to claim 1, wherein when the opening and closing door is opened by sliding to a forward side in the running direction, the opening and closing door allows communication between the cutting space and the external space.

4. The cutting machine according to claim 1, wherein the operating deck unit further includes a locking mechanism which locks opening and closing of the opening and closing door.

5. The cutting machine according to claim 1, wherein the cutting machine body further includes an area sensor that detects an object entering a detection area, and
when the opening and closing door is opened by sliding to a forward side in the running direction, the opening and closing door is positioned in the detection area.

6. The cutting machine according to claim 1, wherein the opening and closing door includes a maintenance window through which a position of the cutting head positioned in the cutting space of the cutting machine body is visually confirmed in a state in which the opening and closing door is closed.

7. The cutting machine according to claim 1, wherein the cutting head is positioned such that a side surface thereof having an adjustment screw unit that adjusts a cutting position of the material to be processed faces the opening and closing door in the cutting space in a state in which the cutting head approaches the opening and closing door.

8. The cutting machine according to claim 1, wherein the operating unit further includes a body operating unit that operates the cutting machine body, and
the body operating unit is provided on a backward side in the running direction with respect to the operating deck unit and the cutting head.

9. The cutting machine according to claim 1, wherein the operating unit further includes a maintenance operating unit that operates locking of opening and closing of the opening and closing door, and
the maintenance operating unit is provided on an upper side of the opening and closing door.

10. The cutting machine according to claim 1, wherein the running carriage includes wheels that rotate on rails positioned in the running direction on both sides of the cutting table, and a wheel cover portion that is positioned on a lower side of the operating unit and has a tip end that protrudes to a forward side of the operating deck unit in the running direction to cover the wheels, and
the wheel cover portion has a cutout portion at the tip end.
